(19) United States
(12) Patent Application Publication
(10) Pub. No.: US 2023/0106772 A1
(43) Pub. Date: Apr. 6, 2023

(54) SYSTEM FOR DETERMINING TRANSPORT ROUTES AND/OR POSITIONS OF GOODS AND TRIGGERING AUTOMATED OPERATIONS

(71) Applicant: BASF SE, Ludwigshafen am Rhein (DE)

(72) Inventors: Andreas WOLLNY, Ludwigshafen am Rhein (DE); Stefania LANFRANCHINI, Ludwigshafen am Rhein (DE); Oliver PIEPER, Carl-Bosch-Strasse 38 (DE); Stefan KOLB, Karlsruhe (DE)

(21) Appl. No.: 17/907,314

(22) PCT Filed: Apr. 12, 2021
(86) PCT No.: PCT/EP2021/059429

§ 371 Date: Sep. 26, 2022

(30) Foreign Application Priority Data
Apr. 14, 2020 (EP) 20169376.9

(51) Int. Cl. G06Q 10/0835; G06Q 10/0833

(52) U.S. Cl. CPC G06Q 10/08355; G06Q 10/0833

(57) ABSTRACT

Described herein is a system for determining transport routes and/or a position of goods. The system includes at least one load carrier unit for transporting and/or storing goods, where the at least one load carrier unit includes data storage means; at least one data collection point, where the at least one load carrier unit and the at least one data collection point include communication means configured to provide a data exchange between the at least one load carrier unit and the at least one data collection point; at least one route and/or position evaluation means configured to determine a route and/or a position of the at least one load carrier unit based on the data exchange; at least one triggering means configured to trigger a predetermined operation on at least one computer unit depending on the determined route and/or position of the at least one load carrier unit.

### FIELD OF INVENTION

The present invention relates to a system for determining the transport routes and/or the position of goods and a method for determining the transport routes and/or the position of goods, wherein based on the determined transport route and/or position of the goods an automated operation is triggered.

### BACKGROUND

At present, independent systems are often used in logistics and production planning. Moreover, the corresponding payment and ordering systems are usually also independent of these systems. Particularly, in the case of cross-company processes, no reliable system exists that can manage logistics, planning, payment and ordering tasks within one system. A further critical point, especially in the case of cross-company exchange, is the question of how such data can be protected against manipulation.

In view of this, it is found that a need exists to provide a system, which can provide the opportunity to manage planning, logistics, ordering and finance incl. payment tasks within one system. In particular, there is a need to provide a more or less automated system that allows an automated cross-company exchange of goods, payments and other finance, insurance, factoring related transactions, and that meets the high security requirements.

### SUMMARY

In the view of the above, it is an object of the present invention to provide a system, which can provide the opportunity to manage planning, logistics, ordering and finance incl. payment tasks within one system. Moreover, it is in particular the object of the present invention to provide a more or less automated system that allows a cross-company exchange of goods and payments and other finance related transactions that also meets the high security requirements.

These and other objects, which become apparent upon reading the following description are solved by the subject-matter of the independent claims. The dependent claims refer to preferred embodiments of the invention.

According to a first aspect, a system for determining the transport routes and/or the position of goods is provided, comprising: at least one load carrier unit for transporting and/or storing goods, wherein the at least one load carrier unit comprises data storage means configured to store at least identification data comprising at least information with respect to the type of goods and the amount of the goods transported by and/or stored on the load carrier unit; at least one data collection point, wherein the at least one load carrier unit and the at least one data collection point comprise communication means configured to provide a data exchange between the at least one load carrier unit and the at least one data collection point and exchanging at least the identification data; at least one route and/or position evaluation means configured to determine the route and/or the position of the at least one load carrier unit based on the data exchange between the at least one data collection point and the at least one load carrier unit; at least one triggering means configured to trigger a predetermined operation on at least one computer unit depending on the determined route and/or position of the at least one load carrier unit.

In other words, the present disclosure proposes to provide a load carrier unit for transporting and/or storing goods comprising a data carrier/data storage means and communication means for transmitting information about the type of good and the amount of goods via a data collection/acquisition point. Based on the communicated information, position data and/or route data can be determined and certain/predefined operations can be triggered on at least one computing unit. It has been found that standardized operations can be triggered based on the position of the goods or the route of the goods. For example, if the load carrier unit passes an entrance area of a storage room, corresponding inventory data can be generated, a corresponding invoice can be approved and/or corresponding payment instructions can be triggered. For example, if the load carrier passes a goods-out area of a storage room, corresponding inventory data can be generated, a corresponding invoice can be issued, or corresponding debit orders can be triggered. Moreover, an order can also be automatically sent to a supplier to replenish stocks.

The term load carrier means/unit is to be understood broadly and includes all conceivable units that are generally suitable for the transport and/or the storage of goods. In particular, but not conclusively, it is understood to include, for example, the following: a pallet unit, an intermediate bulk container (IBC), a tank unit, a silo unit, an overseas container, a railway car and/or a tank vessel. The term data storage means/unit is also broadly understood and includes all appropriate means allowing such information to be stored electronically. For example, volatile and/or non-volatile forms of data storage units can be used here. Finally, the term data collection point is also to be understood in a broad sense and includes all devices/equipment comprising communication means and which can provide a data exchange with corresponding communication means of the load carrier unit. The evaluation and/or triggering means can be provided by any central or distributed computing unit, e.g. a cloud-computing-solutions and/or data center.

In a possible implementation, the system comprises a plurality of automatic or manually triggered data collection points each having a certain communication range, wherein the route and/or the position of the at least one load carrier unit is determined by the data exchange with a respective data collection point. Thus, it is preferred that a large number of such data collection points are provided distributed in the entire system such that a comparatively reliable positioning/distribution picture of the load carrier units can already be provided by means of the communication recording of the individual data collection points.

In a further possible implementation, the route and/or the position of the at least one load carrier unit is determined by a triangulation method, in case a data exchange can be established with more than two data collection points. In this context, it should be noted that the present disclosure is not limited to a particular type of positioning determination. Rather, all known types of position determination can be used. For example, the positioning may also be provided by means of a signal strength analysis or by using a positioning determination algorithm based on signals in a Low-Power Wide-Area Network (LPWAN). In this respect, it is also possible that the at least one load carrier unit further comprises a position determining unit, preferably a Global Positioning System (GPS), providing positioning data with respect to a position of the at least one load carrier unit and wherein the positioning data are used by the at least one route and/or position evaluation means for determining the route and/or the position of the at least one load carrier unit.

It is preferred that the transmitted data also comprise filling level data, temperature data, brightness data and/or moisture data. Moreover, it is preferred that these data are allocated to the positioning data. Such sensor data can, for example, be recorded by appropriate sensors which can be provided either on the goods and/or the load carrier unit. Alternatively or additionally, corresponding sensors can also be arranged in the transmission/reception range of the data collection point, which record and transmit corresponding sensor data if the load carrier unit is in the transmission/reception range of a data collection point.

In a possible implementation, the operation triggered on the at least one computer unit is generating at least one of the following data:

goods receipt data or goods issue data; inventory data; order data; product or customer or supplier master data; identification data; credit risk management data, customer risk assessment data comprising credit limit definition amongst others based on real-time data of higher consumptions; insurance data (e.g. for transport and re-insurance purposes, amongst others based on localization data); invoicing data (e.g. as support for Vendor Managed Inventory/VMI or Self-Billing agreements; amongst others based on consumption data); banking data; financing data; factoring data (debtor or supplier finance solution, amongst others based on volume data); tokenization data (the conversion of the physical asset into a digital token, amongst others to enable new financing opportunities); payment data (amongst other to trigger automatic, IoT-supported Machine-to-Machine payments, coordinated by in Smart Contracts defined rules and standards); clearing data (amongst others to enable automatic account maintenance at supplier and buyer side); tax data (amongst others to support tax monitoring and declaration needs); customs data (amongst others to support customs monitoring and declaration needs); accounting/general ledger data (amongst others to support Month and Year End Closing routines and processes); official (trade) statistics data (amongst others to contribute additionally and with real-time data to official (trade) statistics data); and/or quality data. In this respect, it is further preferred that the operation triggered on the at least one computer unit is also issuing at least one of the following messages: goods receipt message, goods outgoing message or goods issue message, inventory message, order message, credit risk management message, identification message, insurance message, invoicing message, banking message, financing message, factoring message, tokenization message, payment message; clearing message, tax message, customs message, accounting/general ledger message and/or release message. It is further preferred that the system comprises display and/or printing means outputting the generated data and/or message. In this context, it should be noted that the present disclosure is not limited to a specific operation, but can rather trigger all “occurring” operations as long as these can be predetermined/determined based on the position or route of the goods.

It is in particular preferred that these data are generated/added using Distributed Ledger Technology (DLT) or shared ledger technology. A distributed ledger is a consensus of replicated, shared, and synchronized digital data geographically spread across multiple sites, countries, or institutions. There is no central administrator or centralized data storage. In this respect, it is preferred that the manufacturers, the suppliers, customers, and all other participants provide/form a peer-to-peer network using a common consensus algorithm. The distributed ledger is spread across the nodes/devices on the peer-to-peer network, where each replicates and saves an identical copy of the ledger and updates itself independently. When a ledger update happens, each node constructs the new transaction, and then the nodes vote by consensus algorithm on which copy is correct. Once a consensus has been determined, all the other nodes update themselves with the new, correct copy of the ledger.

As a result, it is in particular preferred to combine the Internet of Things (IoT) technology for triggering respective operations based on the position and/or route of the goods and distributed ledger technology for providing a most secure communication channel. Thereby, also cross-company transactions can be performed in a very secure and reliable manner and all those involved can check whether the data are authentic or whether the ledger has been manipulated. Therefore, it is now also possible to automate the payment and other finance related transactions corresponding to purchases and sales. By using the Distributed Ledger Technology (DLT), it is possible to eliminate the possibility that the ledger is unrecognized manipulated and all transactions can be reliably traced, if necessary, even retrospectively. In this respect, amongst others Direct Debit procedures, like SEPA or e-Money-based Cash-on-Ledger solutions, can be used between business partners to trigger automatic payments and automatic clearings.

In a further implementation, the system further comprises data collection means configured to collect analysis data with respect to the identification data of the at least one load carrier unit, the determined route and/or positions of the at least one load carrier unit and/or the triggered predetermined operations.

According to a second aspect, a method for detecting the transport routes and/or the position of goods, its consumption, replacement and replenishment, comprising the steps: providing a system for detecting the transport routes and/or the position of goods as described above; determining at least one route and/or position of at least one load carrier unit by position evaluation means based on a data exchange between at least one data collection point and at least one load carrier unit; triggering by at least one triggering means a predetermined operation on at least one computer unit depending on the determined route and/or position of the at least one load carrier unit. With respect to the possible implementation and the provided advantages, it is referred to the above explanations which apply also with respect to this method.

A further aspect refers to a use of at least one load carrier unit for transporting and/or storing goods, wherein the at least one load carrier unit comprises data storage means configured to store at least identification data comprising at least information with respect to the type of goods and the amount of the goods transported by and/or stored on the load carrier unit in a system or method explained above. Further aspects refer to a use of at least one data collection point configured to provide a data exchange between at least one load carrier unit in a system/method explained above, a use of analysis data as input data for an analysis algorithm for estimating and/or predicting the stock quantities and/or product consumption and/or transport times and/or required replenishment in a system/method explained above, and to a use of analysis data as input data for a simulation and/or optimization of a system/method explained above, e.g. financial optimization, cash flow optimization, payment optimization and/or factoring optimization.

The analysis algorithm for estimating and/or predicting the stock quantities and/or transport times and/or required replenishment in a system/method explained above can be performed by a central computing device or a cloud computing solution. In this respect, it is preferred that analysis algorithm is based on the results of a machine-learning algorithm. The machine-learning algorithm preferably comprises decision trees, naive Bayes classifications, nearest neighbors, neural networks, convolutional neural networks, generative adversarial networks, support vector machines, linear regression, logistic regression, random forest and/or gradient boosting algorithms. Preferably, the machine-learning algorithm is organized to process an input having a high dimensionality into an output of a much lower dimensionality. Such a machine-learning algorithm is termed “intelligent” because it is capable of being “trained”. The algorithm may be trained using records of training data. A record of training data comprises training input data and corresponding training output data. The training output data of a record of training data is the result that is expected to be produced by the machine-learning algorithm when being given the training input data of the same record of training data as input. The deviation between this expected result and the actual result produced by the algorithm is observed and rated by means of a “loss function”. This loss function is used as a feedback for adjusting the parameters of the internal processing chain of the machine-learning algorithm. For example, the parameters may be adjusted with the optimization goal of minimizing the values of the loss function that result when all training input data is fed into the machine-learning algorithm and the outcome is compared with the corresponding training output data. The result of this training is that given a relatively small number of records of training data as “ground truth”, the machine-learning algorithm is enabled to perform its job well for a number of records of input data that higher by many orders of magnitude.

The present disclosure also relates to a computer program or computer program element configured to execute the above explained method, on an appropriate apparatus or system.

The computer program element might therefore be stored on a computer unit, which might also be part of an embodiment. This computing unit may be configured to perform or induce performing of the steps of the method described above. Moreover, it may be configured to operate the components of the above described apparatus and/or system. The computing unit can be configured to operate automatically and/or to execute the orders of a user. A computer program may be loaded into a working memory of a data processor. The data processor may thus be equipped to carry out the method according to one of the preceding embodiments.

This exemplary embodiment of the present disclosure covers both, a computer program that right from the beginning uses the present disclosure and computer program that by means of an update turns an existing program into a program that uses the present disclosure.

Further on, the computer program element might be able to provide all necessary steps to fulfill the procedure of an exemplary embodiment of the method as described above.

According to a further exemplary embodiment of the present disclosure, a computer readable medium, such as a CD-ROM, USB stick or the like, is presented wherein the computer readable medium has a computer program element stored on it, which computer program element is described by the preceding section. A computer program may be stored and/or distributed on a suitable medium, such as an optical storage medium or a solid state medium supplied together with or as part of other hardware, but may also be distributed in other forms, such as via the internet or other wired or wireless (tele-) communication systems.

However, the computer program may also be presented over a network like the World Wide Web and can be downloaded into the working memory of a data processor from such a network. The use of cloud computing solutions is also possible. According to a further exemplary embodiment of the present disclosure, a medium for making a computer program element available for downloading is provided, which computer program element is arranged to perform a method according to one of the previously described embodiments of the disclosure.

As result, the present disclosure provides a system/method with which financial and statistical processes can be supported/authenticated; flow of goods can be monitored and can be controlled; inventory can be kept at an optimal level across the related companies and a “delivery on demand” can be provided; “just in time” deliveries are possible; ordering, booking, delivery, invoicing, insuring, release, banking, financing, tokenization, payments and clearings—also via e-money-, and generating and sharing of tax, customs and statistical data as components of business management processes can be carried out quickly, traceably, automatically, optimized and authenticated; wherein all these processes/operations can be triggered by the physical transport of a load carrier unit, e.g. a sensor-controlled pallet or other units as described above that can be uniquely identified.

Based on generated data from processes already carried out, the system can compare, analyze and predict the model used, e.g. required storage quantities, transport times, optimize order processing, simulate/model optimized processes to increase efficiency.

The present disclosure also relates to a system for determining the transport routes and/or the position of goods, comprising: at least one load carrier unit for transporting and/or storing goods, wherein the at least one load carrier unit comprises data storage means configured to store at least identification data comprising at least information with respect to the type of goods and the amount of the goods transported by and/or stored on the load carrier unit; at least one data collection point, wherein the at least one data collection point comprises communication means and/or scanning means configured to obtain at least the identification data; at least one route and/or position evaluation means configured to determine the route and/or the position of the at least one load carrier unit based on the data exchange between the at least one data collection point and the at least one load carrier unit; at least one triggering means configured to trigger a predetermined operation on at least one computer unit depending on the determined route and/or position of the at least one load carrier unit. In this example, the identification data can be provided, for example, by a label, such as a so-called Global Transport Label, which is scanned manually or automatically at a data collection point. Apart from that, all the explanations already mentioned above also apply accordingly to this example.

### BRIEF DESCRIPTION OF THE DRAWINGS

In the following, the invention is described exemplarily with reference to the enclosed figure, in which:

FIG. 1 is a schematic view of a system according to the preferred embodiment; and

FIG. 2 is a schematic view of a method according to the preferred embodiment.

### DETAILED DESCRIPTION OF EMBODIMENTS

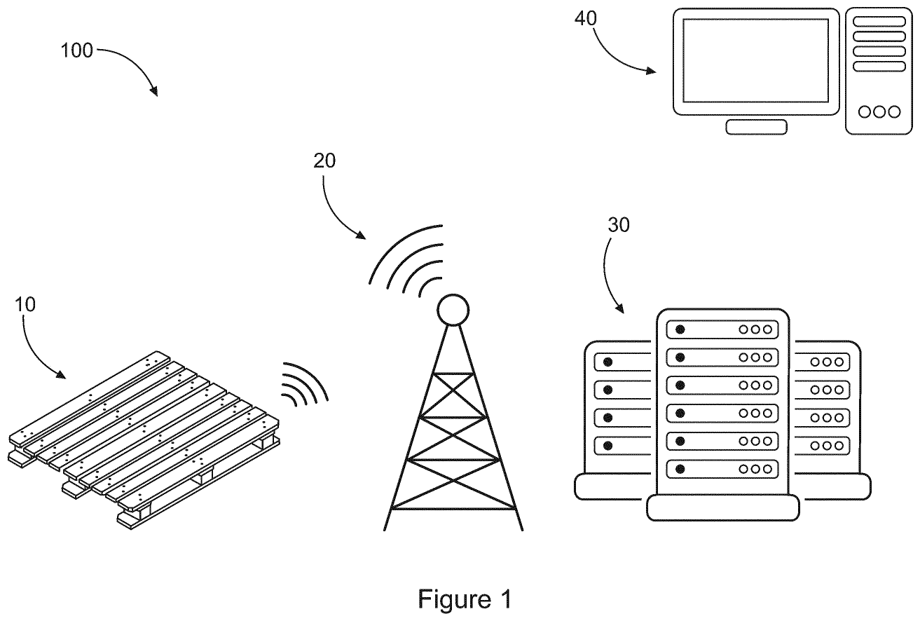

FIG. 1 is a schematic view of a system 100 for determining the transport routes and/or the position of goods comprising: at least one load carrier unit 10 for transporting and/or storing goods, wherein the at least one load carrier unit 10 comprises data storage means (not shown) configured to store at least identification data comprising at least information with respect to the type of goods and the amount of the goods transported by and/or stored on the load carrier unit 10; at least one data collection point 20, wherein the at least one load carrier unit 10 and the at least one data collection point 20 comprise communication means configured to provide a data exchange between the at least one load carrier unit 10 and the at least one data collection point 20 and exchanging at least the identification data; at least one route and/or position evaluation means 30 configured to determine the route and/or the position of the at least one load carrier unit 10 based on the data exchange between the at least one data collection point 20 and the at least one load carrier unit 10; at least one triggering means 30 configured to trigger a predetermined operation on at least one computer unit 40 depending on the determined route and/or position of the at least one load carrier unit 10.

In the preferred embodiment, the load carrier unit 10 is provided by a pallet unit 10. However, any other load and/or transportation unit can be used as load carrier unit 10, e.g. an intermediate bulk container (IBC), a tank unit, a silo unit, an overseas container, a railway car, a tank vessel, and so forth. The load carrier unit 10 comprises a data storage unit (not shown) for storing at least information with respect to the type of goods and the amount of the goods transported by and/or stored on the load carrier unit 10.

The data collection point 20 can be provided by any means comprising communication means providing a data communication with the communication means of the load carrier unit 10, e.g. Bluetooth-Device, WLAN-Device, or any other short or middle range communication device. In the preferred embodiment, the system 100 comprises a plurality of automatic or manually triggered data collection points 20 each having a certain communication range, wherein the route and/or the position of the at least one load carrier unit 10 is determined by the data exchange with a respective data collection point 20. Thus, it is preferred that a large number of such data collection points 20 are provided distributed in the entire system 100 such that a comparatively reliable positioning/distribution picture of the load carrier units 10 can already be provided by means of the communication recording of the individual data collection points 20.

The evaluation means 30 and/or triggering means 30 can be provided by any central or distributed computing unit, e.g. a cloud-computing-solutions and/or data center solution. As shown in FIG. 1, the evaluation means 30 and the triggering means 30 may also be implemented in one computer unit.

The operation (automatically) triggered on the at least one computer unit 40 is preferably generating at least one of the following data: goods receipt data or goods issue data, inventory data, order data, product master data, identification data, credit risk management data, insurance data, invoicing data, banking data, financing data, factoring data, tokenization data, payment data, clearing data, tax data, customs data, accounting/general ledger data, official (trade) statistics data (e.g. Intrastat in Europe) and/or quality data. In this respect, it is further preferred that the operation triggered on the at least one computer unit is also issuing at least one of the following messages: goods receipt message, goods outgoing message or goods issue message, inventory message, order message, product master data message, identification message, credit risk management message, insurance message, invoicing message, banking message, financing message, factoring message, tokenization message, payment message, release message, clearing message, tax message, customs message, accounting/general ledger message, official (trade) statistics message (e.g. Intrastat in Europe) and/or quality message. However, any other “occurring” operation may be triggered by the triggering means as long as such operation can be predetermined/determined based on the position or route of the goods/load carrier unit 10. It is in particular preferred that these data are generated using Distributed Ledger Technology (DLT) or shared ledger technology. A distributed ledger is a consensus of replicated, shared, and synchronized digital data geographically spread across multiple sites, countries, or institutions. There is no central administrator or centralized data storage. In this respect, it is preferred that the manufacturers, the suppliers, customers, and all other participants provide/form a peer-to-peer network using a common consensus algorithm. The distributed ledger is spread across the nodes/devices on the peer-to-peer network, where each replicates and saves an identical copy of the ledger and updates itself independently. When a ledger update happens, each node constructs the new transaction, and then the nodes vote by consensus algorithm on which copy is correct. Once a consensus has been determined, all the other nodes update themselves with the new, correct copy of the ledger. As a result, it is in particular preferred to combine the Internet of Things (IoT) technology for triggering respective operations based on the position and/or route of the goods and distributed ledger technology for providing a most secure communication channel. Thereby, also cross-company transactions can be performed in a very secure and reliable manner and all those involved can check whether the data are authentic or whether the ledger has been manipulated. Therefore, it is now also possible to automate the payment and all other finance-, banking-, tax-, customs- and official statistics-related transactions corresponding to purchases and sales. By using the Distributed Ledger Technology (DLT), it is possible to eliminate the possibility that ledger has been unrecognized manipulated and all transactions can be reliably traced, if necessary, even retrospectively. In this respect, e.g. Direct Debit procedures, like SEPA or e-Money-based Cash-on-Ledger solutions, can be used between business partners to trigger payments.

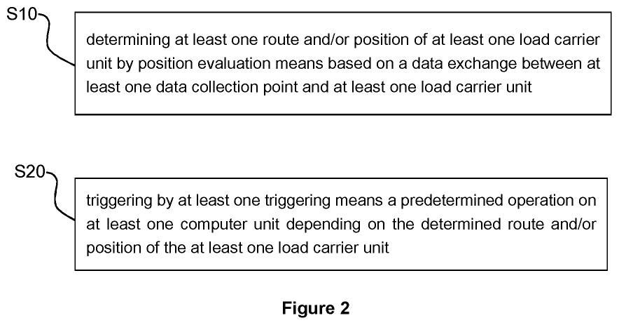

FIG. 2 shows a schematic view of a method according to the preferred embodiment.

In step 10 at least one route and/or position of the at least one load carrier unit 10 by the position evaluation means 30 based on a data exchange between the at least one data collection point 20 and at least one load carrier unit 10 is determined. In step 20 by the at least one triggering means 30, a predetermined operation on the at least one computer unit 40 is triggered depending on the determined route and/or position of the at least one load carrier unit 10. For example, if the load carrier unit passes an entrance area of a storage room, corresponding inventory data can be generated, a corresponding invoice can be approved and/or corresponding payment and clearing instructions can be triggered. For example, if the load carrier passes a goods-out area of a storage room, corresponding inventory data can be generated, a corresponding invoice can be issued, or corresponding debit orders can be triggered. Moreover, an order can also be automatically sent to a supplier to replenish stocks.

The present invention has been described in conjunction with a preferred embodiment as examples as well. However, other variations can be understood and effected by those persons skilled in the art and practicing the claimed invention, from the studies of the drawings, this disclosure and the claims. Notably, in particular the steps S10 to S20 can be performed in any order, i.e. the present invention is not limited to a specific order of these steps. Moreover, it is also not required that the different steps are performed at a certain place or at one place, i.e. each of the steps or parts of the steps may be performed at a different place using different equipment/data processing units. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

### REFERENCE SIGNS

10 load carrier unit
20 data collection point
30 evaluation and triggering means
40 computer unit
S10 determining a route and/or a position of a load carrier unit
S20 triggering a predetermined operation on at least one computer unit

1. A system for determining transport routes and/or a position of goods, comprising:
at least one load carrier unit for transporting and/or storing goods, wherein the at least one load carrier unit comprises data storage means configured to store at least identification data comprising at least information with respect to a type of goods and an amount of the goods transported by and/or stored on the at least one load carrier unit;
at least one data collection point, wherein the at least one load carrier unit and the at least one data collection point comprise communication means configured to provide a data exchange between the at least one load carrier unit and the at least one data collection point for exchanging at least the identification data;
at least one route and/or position evaluation means configured to determine a route and/or a position of the at least one load carrier unit based on the data exchange between the at least one data collection point and the at least one load carrier unit;
at least one triggering means configured to trigger a predetermined operation on at least one computer unit depending on the determined route and/or position of the at least one load carrier unit.

2. The system according to claim 1, wherein the system further comprises a plurality of automatic or manually triggered data collection points each having a certain communication range, wherein the route and/or the position of the at least one load carrier unit is determined by the data exchange with a respective data collection point.

3. The system according to claim 1, wherein the route and/or the position of the at least one load carrier unit is determined by a triangulation method, in case the data exchange can be established with more than two data collection points.

4. The system according to claim 1, wherein the route and/or the position of the at least one load carrier unit is determined by means of a signal strength analysis or by using a positioning determination algorithm based on signals in a Low-Power Wide-Area Network (LPWAN).

5. The system according to claim 1, wherein the at least one load carrier unit further comprises a position determining unit providing positioning data with respect to the position of the at least one load carrier unit and wherein the positioning data are used by the at least one route and/or position evaluation means for determining the route and/or the position of the at least one load carrier unit.

6. The system according to claim 1, wherein the operation triggered on the at least one computer unit is generating at least one of the following data:
goods receipt data or goods issue data;
inventory data;
order data;
master data;
identification data;
credit risk management data;
insurance data;
invoicing data;
banking data;
financing data;
factoring data;
tokenization data;
payment data;
clearing data;
tax data;
customs data;
accounting/general ledger data;
official (trade) statistics data; and/or
quality data.

7. The system according to claim 1, wherein the operation triggered on the at least one computer unit is issuing at least one of the following messages:
a goods receipt message, a goods outgoing message or a goods issue message;
an inventory message;
an order message;
a product master data message;
an identification message;
a credit risk management message;
an insurance message;
an invoicing message;
a banking message;
a financing message;
a factoring message;
a tokenization message;
a payment message;
a release message;
a clearing message;
a tax message;
a customs message;
an accounting/general ledger message;
an official (trade) statistics message; and/or
a quality message.

8. The system according to claim 7, wherein the system further comprises display and/or printing means for outputting the issued message.

9. The system according to claim 1, wherein the at least one load carrier unit is a pallet unit, an intermediate bulk container (IBC), a tank unit, a silo unit, an overseas container, a railway car or a tank vessel.

10. The system according to claim 1, wherein the system further comprises data collection means configured to collect analysis data with respect to the identification data, the determined route and/or positions of the at least one load carrier unit and/or the triggered predetermined operations.

11. A method for determining transport routes and/or position of goods, comprising the steps:
providing the system for determining the transport routes and/or the position of goods according to claim 1;
determining at least one route and/or position of at least one load carrier unit by position evaluation means based on a data exchange between at least one data collection point and the at least one load carrier unit; and
triggering by at least one triggering means a predetermined operation on at least one computer unit depending on the determined route and/or position of the at least one load carrier unit.

12. A method of using at least one load carrier unit, comprising using the at least one load carrier unit for transporting and/or storing goods, wherein the at least one load carrier unit comprises data storage means configured to store at least identification data comprising at least information with respect to a type of goods and an amount of the goods transported by and/or stored on the at least one load carrier unit in the system according to claim 1.

13. A method of using at least one data collection point configured to provide a data exchange between at least one load carrier unit, comprising using the at least one data collection point in the system according to claim 1.

14. A method of using analysis data, comprising using the analysis data as input data for an analysis algorithm for estimating and/or predicting stock quantities and/or predicting transport times and/or predicting required replenishment and/or for a simulation and/or for optimization of a system in the system according to claim 1.

15. A computer program element which when executed by a processor is configured to carry out the method according to claim 11.

16. The system according to claim 1, wherein the at least one load carrier unit further comprises a Global Positioning System (GPS) providing positioning data with respect to the position of the at least one load carrier unit and wherein the positioning data are used by the at least one route and/or position evaluation means for determining the route and/or the position of the at least one load carrier unit.

17. The system according to claim 6, wherein the system further comprises display and/or printing means for outputting the generated data.
